(19) United States
(12) Patent Application Publication
(10) Pub. No.: US 2004/0090449 A1
(43) Pub. Date: May 13, 2004

(54) Method and program for increassing field engineer performance and providing self-paced training

(75) Inventor: R. Michael MacLellan, Waukesha, WI (US)

Correspondence Address: JOSEPH S. HEINO, ESQ., 111 E. KILBOURN AVENUE, SUITE 1400, MILWAUKEE, WI, 53202, US

(73) Assignee: GE Medical Systems Global Technology Company, L.L C., Waukesha, WI

(21) Appl. No.: 10/293,009

(22) Filed: Nov. 13, 2002

(51) Int. Cl. G09G 5/00

(52) U.S. Cl. 345/709; 345/760

(57) ABSTRACT

A method and program provides a CD-ROM based tool, known as the multivendor electronic performance support tool with self-paced training (ePST/SPT), that is designed from a field service and training perspective. The method and program provides service documentation in a consistent format and structure throughout each OEM and modality product. Each OEM and modality product is displayed on a screen and includes a plurality of hyperlinks to various technical areas related to that equipment modality. Included in the technical information hyperlinks are such subject areas as alignment and calibration, component locations, error codes, functional checks, log preventive maintenance, software and diagnostics, theory and/or trouble shooting. Within each hyperlink is a plurality of cross-links between the different technical information areas relating to the equipment modality.

### BACKGROUND OF THE INVENTION

This invention relates generally to methods and programs for increasing the technical capability, competence and productivity of field engineers. More particularly, it relates to a method and program for training field engineers with respect to a wide variety of equipment by providing service information in a system functional-service functional approach.

Field engineers are frequently required to service many types of high technology machines such as medical imaging devices. Imaging devices may include magnetic reasonance imaging (MRI), computerized tomography (CT), X ray and ultrasound technologies. Each of these machines requires a high degree of expertise to service. Generally, to provide efficient service, technicians must be highly trained to service more than one type of machine.

Service documentation in technical fields is typically developed in an engineering environment and is designed based on the layout of the physical system. In other words, service documentation developed in an engineering environment typically addresses only a very specific part of the machine and leaves the field engineer to diagnose the problems encountered by the user. Further complicating the problem, each product generally has some service documentation that has its own format and structure. Such documentation typically lacks uniformity from one piece of equipment to the next.

Obviously, there is a need to improve the efficiency and technical capability of field engineers. Equally compelling is a need to reduce the costs associated with training field engineers. The purpose of the method and program of the present invention is to provide a comprehensive diagnostic and instruction tool that alleviates the aforementioned problems.

### BRIEF SUMMARY OF THE INVENTION

The method and program of the present invention provides a CD-ROM based tool, known as the multivendor electronic performance support tool with self-paced training (ePST/SPT), that is designed from a field service and training perspective instead of an engineering perspective. The method and program provides service documentation in a consistent format and structure throughout each OEM and modality product. The method of the present invention further provides a system function—service function approach. That is, instead of the traditional engineering approach, which may be to address potential problems by physical component, the method and program of the present invention provides interlinked logic diagrams, diagnostic questions and calibration information required to service system functions, as opposed to system components. Information required to repair system components is then electronically recalled.

Accordingly, one object of the method and program of the present invention is to provide a service program that returns the correct service information to the field engineer without confusing the field engineer with unnecessary information.

Another object of the present invention is to provide for the training of field engineers with respect to a wide range of OEM products by use the uniform method and program such as that provided by the present invention. Improved field engineer competency on both the method of the present invention and on the products themselves will improve familiarity with the products, efficiency in field, as well as increase customer satisfaction and decrease service costs.

The method and program of the present invention is a powerful tool that will provide field engineers with a consistent look and feel to all training and service information for every product. This consistent look will improve the comfort level of field engineers while servicing various equipment modalities of various OEMs, thereby increasing the productivity of the field engineer.

The foregoing and other features of the method and program of the present invention will be apparent from the detailed decription that follows.

### BRIEF DESCRIPTION OF THE DRAWINGS

FIG. 1 is a screen display illustrating one OEM device that is incorporated into the method and program of the present invention, the OEM device being one of many.

FIG. 2 is a screen display illustrating the “alignment and calibration” options available to the field engineer relative to the OEM device.

FIG. 3 is a screen display illustrating the alignment and calibration procedures for “gantry tilt adjustment” in the OEM device.

FIG. 4 is a screen display illustrating the “component location” options for the OEM device.

FIG. 5 is a screen display illustrating the pictorial and word instructions for replacement of the gantry air filter in the OEM device.

FIG. 6 is a screen display illustrating the “error codes” for the OEM device.

FIG. 7 is a screen display illustrating instructions for viewing and interpreting the error log for the OEM device.

FIG. 8 is a screen display showing a table relative to “PHS errors” in the OEM device.

FIG. 9 is a screen display illustrating the “functional checks and procedures” options for the OEM device.

FIG. 10 is a screen display illustrating test points of various boards in the OEM device.

FIG. 11 is a screen display illustrating the “logic and block diagram” options of the OEM device.

FIG. 12 is a screen display illustrating the logic and block diagram of the “anode control” of the OEM device.

FIG. 13 is a screen display illustrating the “preventive maintenance” options of the OEM device.

FIG. 14 is a screen display illustrating the “How to . . . ” index for various common procedures relative to the OEM device.

FIG. 15 is a screen display illustrating instructions for preventive maintenance relative to the “gantry drive belt” of the OEM device.

FIG. 16 is a screen display illustrating “software and diagnostics” options of the OEM device.

FIG. 17 is a screen display illustrating the “system startup” instructions of the OEM device.

FIGS. 18 and 19 are a screen displays illustrating the “system shutdown” instructions of the OEM device.

FIG. 20 is a screen display illustrating the “theory” areas of inquiry relative to the OEM device.

FIGS. 21 and 22 are a screen displays illustrating the theory behind the “high voltage and x-ray generation” of the OEM device.

FIG. 23 is a screen display illustrating the “troubleshooting options” relative to the OEM device.

FIG. 24 is a screen display illustrating the troubleshooting diagram relative to “audio” in the OEM device.

### DETAILED DESCRIPTION OF THE INVENTION

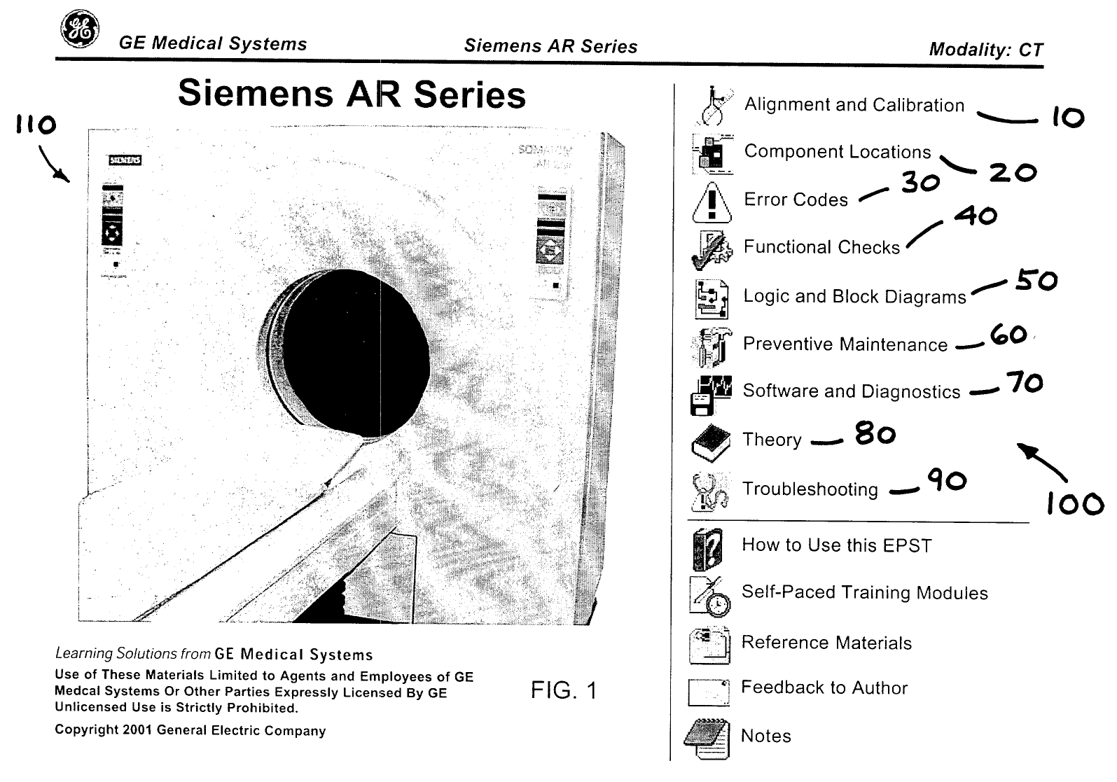

Referring now to the drawings in detail wherein like reference numerals represent like elements throughout, FIG. 1 illustrates a typical screen display in accordance with the method and system of the present invention. As discussed earlier, the multivendor electronic performance support tool with self-paced training of the present invention is a CD Rom based tool that is designed from a field service and training perspective rather than an engineering perspective. It maintains a consistent format and structure throughout all OEM and modality products. This format and structure takes a system functional and service functional approach. Each system is broken down into its functional rather than it physical components. Documentation is developed for each identified system function as well as a field service functions that are required to service the associated system function. All information is then electronically linked between the system functions and the service functions. This is key to providing the field engineer with the correct service information at the time he or she needs it without delaying and confusing him or her with information that is not needed at the moment.

The method and program of the present invention also integrates e-training with the actual tool (ePST) that the field engineer will use while maintaining the equipment in the field. System training, coupled with the actual service tool used by the field engineer, improves field engineer competency on both the product and on the service tool itself. This results in increased productivity for the field engineer and thereby resulting in increased customer satisfaction and decreased service costs.

FIG. 1 illustrates a screen display for only one of many OEM products that are included in the method and program of the present invention. As shown, the product is a computerized tomography scanner, known by its manufacturer as the AR CT machine. The first display page illustrates a graphical image 110 of the machine itself and a number of system function options or categories, generally identified 100, relative to that particular piece of OEM radiographic equipment. Specifically, the field engineer, either in training or in the field, can access options or categories 100 delineated as

alignment and calibration 10,

component locations 20,

error codes 30,

functional checks 40,

logic and block diagrams 50,

preventive maintenance 60,

software and diagnostics 70,

theory 80, and

troubleshooting 90 for any machine of this particular AR series.

Each category 100 has its own icon and is hyperlinked to cross reference a number of other areas which will become apparent later in this detailed disclosure. It is also possible to include other icons, categories or subcategories as such is desired or required.

The field engineer viewing this first screen shown in FIG. 1 may, for example, want to understand the concept behind the operation or functionality of the AR series of CT machines and would access the theory category 80 in accordance with the method and system of the present invention. The theory category 80 is particular to this machine and will educate or familiarize the field engineer with the theory of operation of the particular machine. This is significant because it may be that operating systems are unique in both operation as well as construction and certain radiographic imaging machines have similar elements, but may vary from one manufacturer to another in implementation.

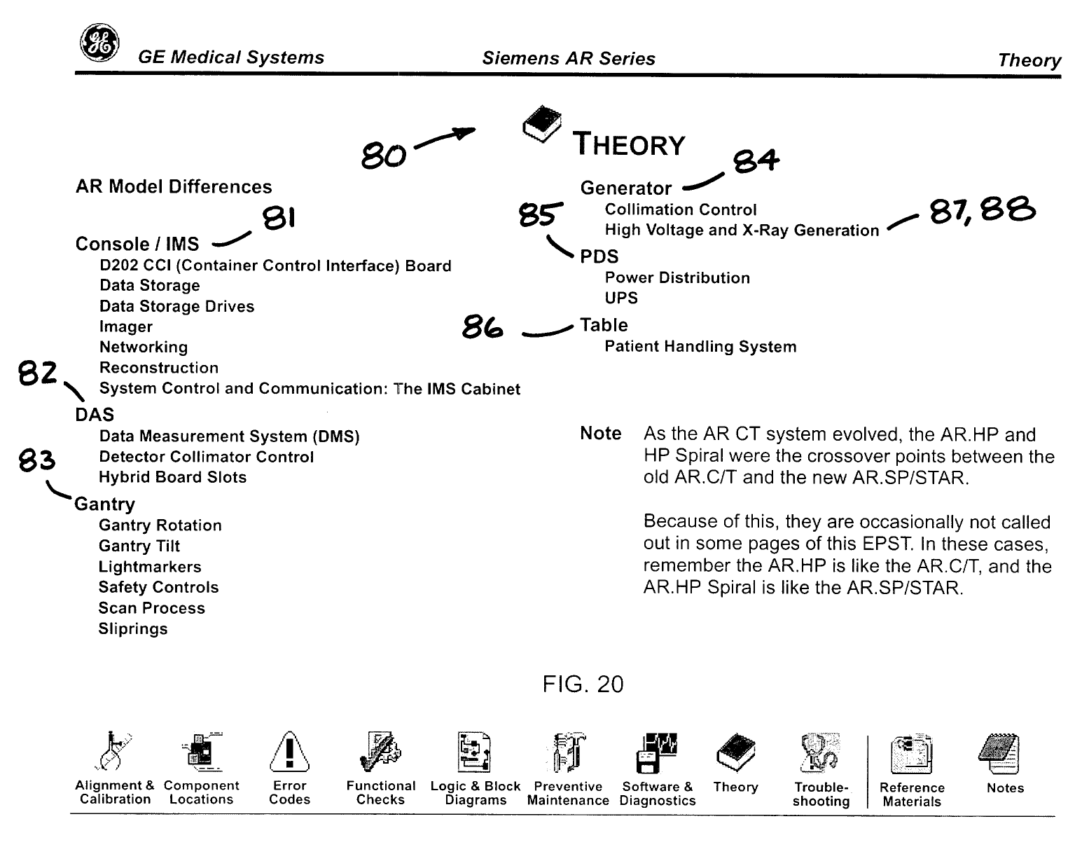

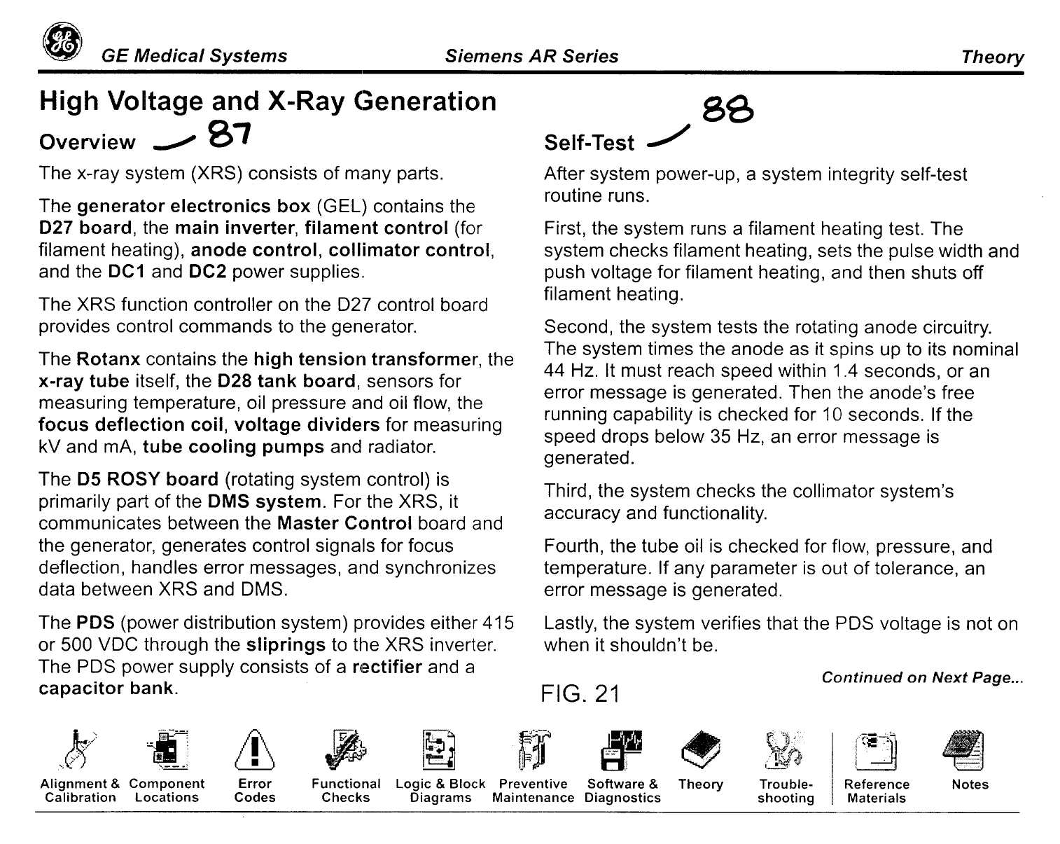

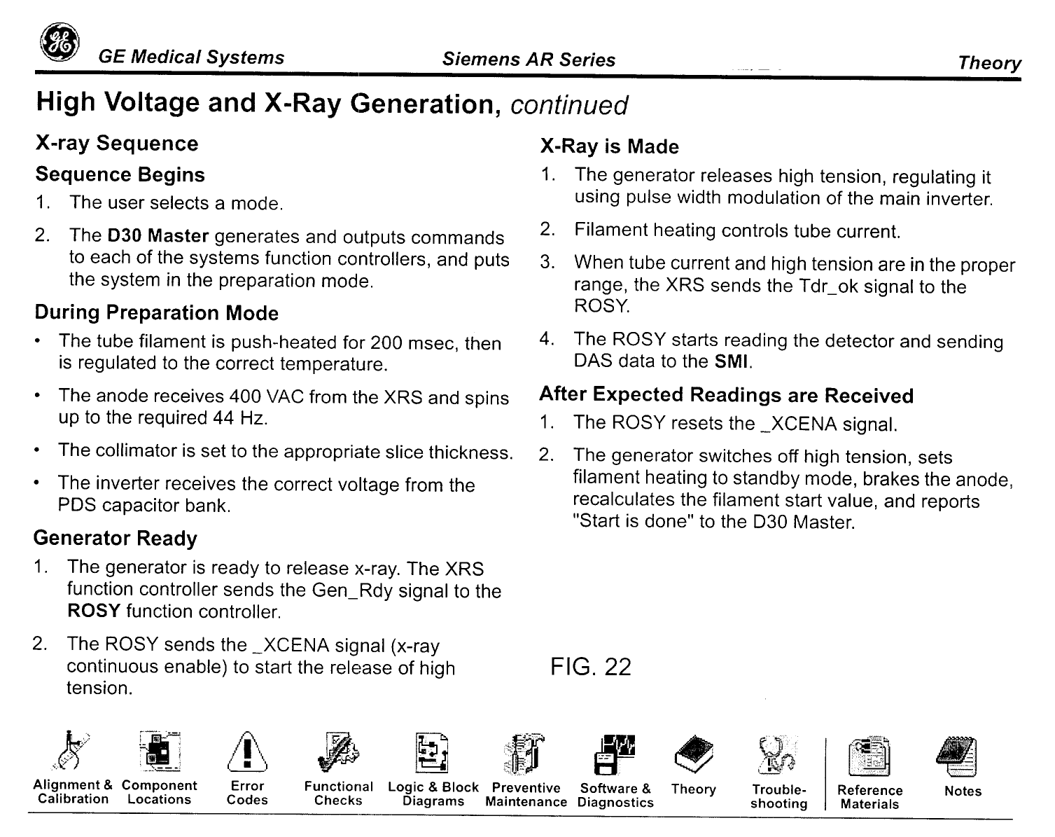

Referring now to FIG. 20, it will be seen that the theory category 80 of the AR CT covers various subcategories of the machine including the console 81, the data acquisition system (DAS) 82, the gantry 83, the generator 84, the power distribution system (PDS) 85, and the table, or the patient handling system (PHS) 86. By accessing these different areas, the field engineer can become educated with respect to, or re-familiarized with, any particular aspect of that machine. Of course, different machines would include different areas and the present invention is not limited to only those shown in FIG. 20. An example of a subcategory is illustrated in FIGS. 21 and 22 which provide an overview 87 of the high voltage and x-ray generation portions of the machine and an explanation of a self-test sequence 88 that is run for determining system integrity.

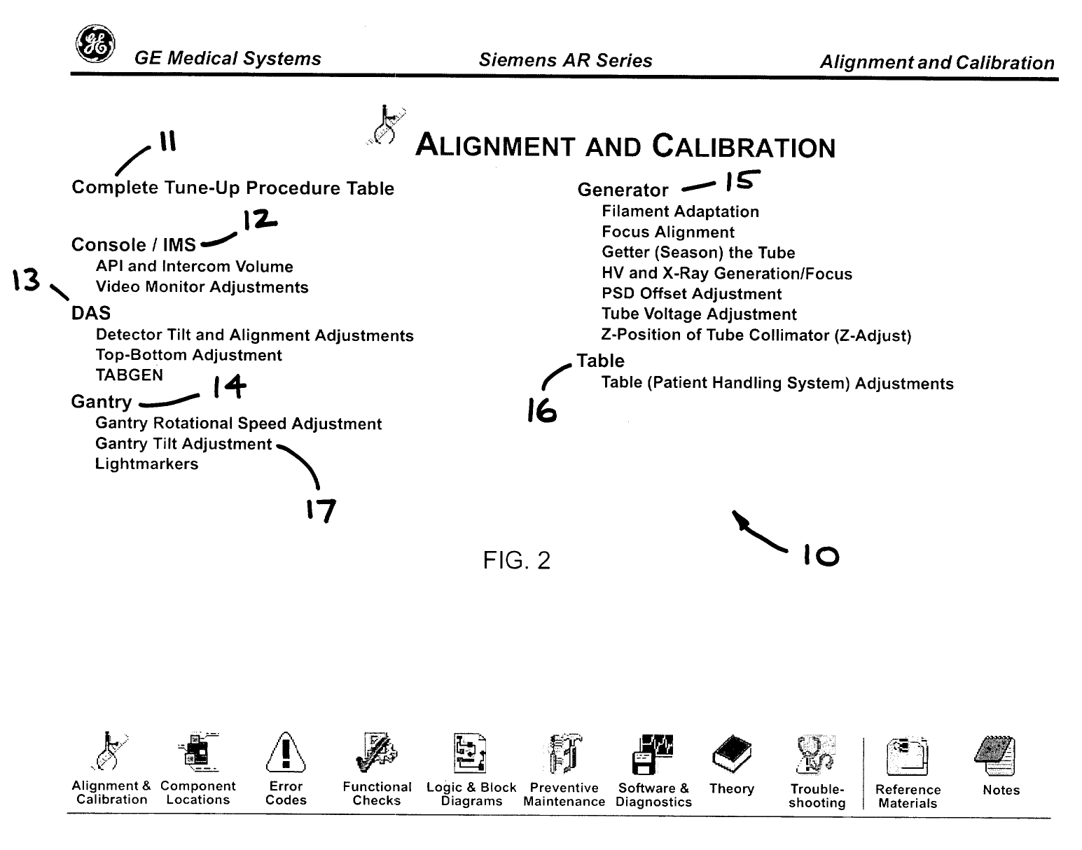

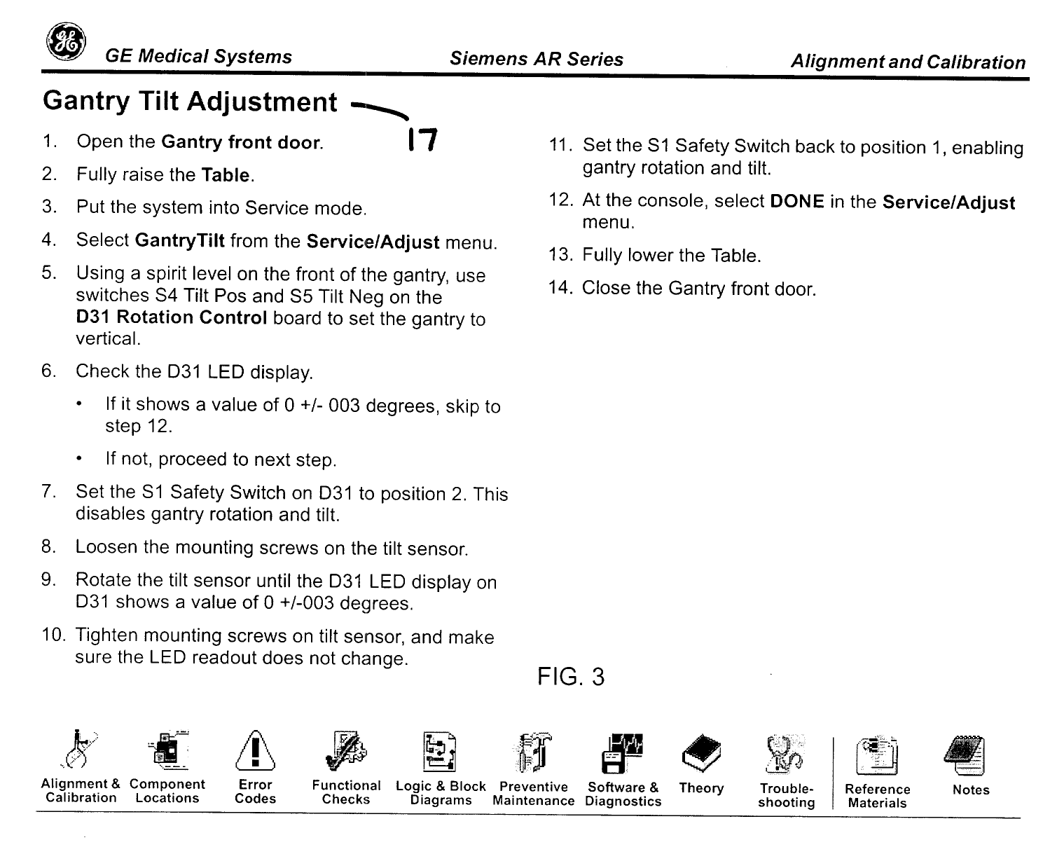

Referring back to the initial page in the screen display shown at FIG. 1, which first page is easily accessed back by the operator, the field engineer may inquire as to alignment and calibration 10 for the AR CT machine involved. The field engineer does this by clicking on the “Alignment and Calibration” icon 10. Doing so opens the page as shown in FIG. 2. In the example given, alignment and calibration 10 are included to provide important information regarding complete tune-up 11 of the subject imaging machine. It also provides alignment and calibration information 10 for particular subassemblies of the machine, including the console 12, the data acquisition system 13, the gantry 14, the x-ray generator 15, and the table or patient handling system 16. Each subassembly, in turn, includes a number of component parts, each of which may be hyperlinked to other separate documents that illustrate proper alignment and calibration information for those component parts. For example, if the field engineer were interested in proper calibration of the tilt of the gantry for this particular machine, the field engineer would scroll to the “Gantry” category 14 and click on the subcategory entitled “Gantry Tilt Adjustment” 17 which would open a screen display as shown in FIG. 3. That screen display shows, step by step, the alignment format to be followed for the tilt of the gantry of this particular piece of equipment.

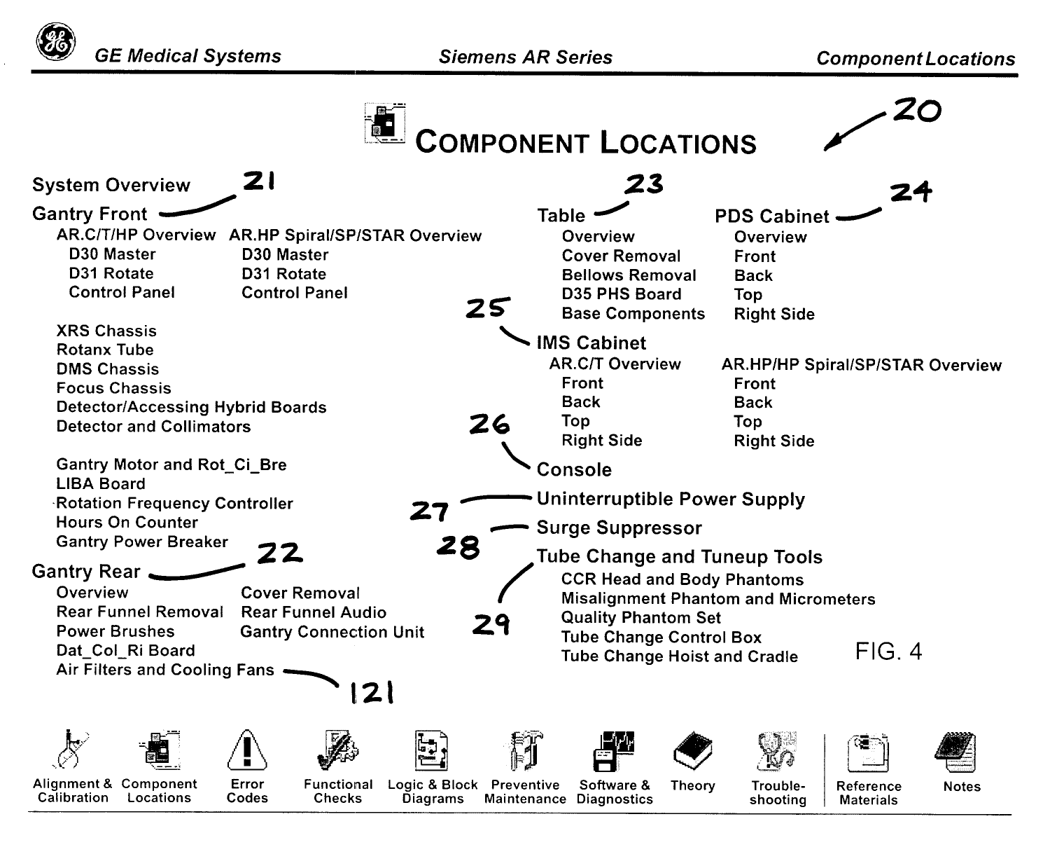

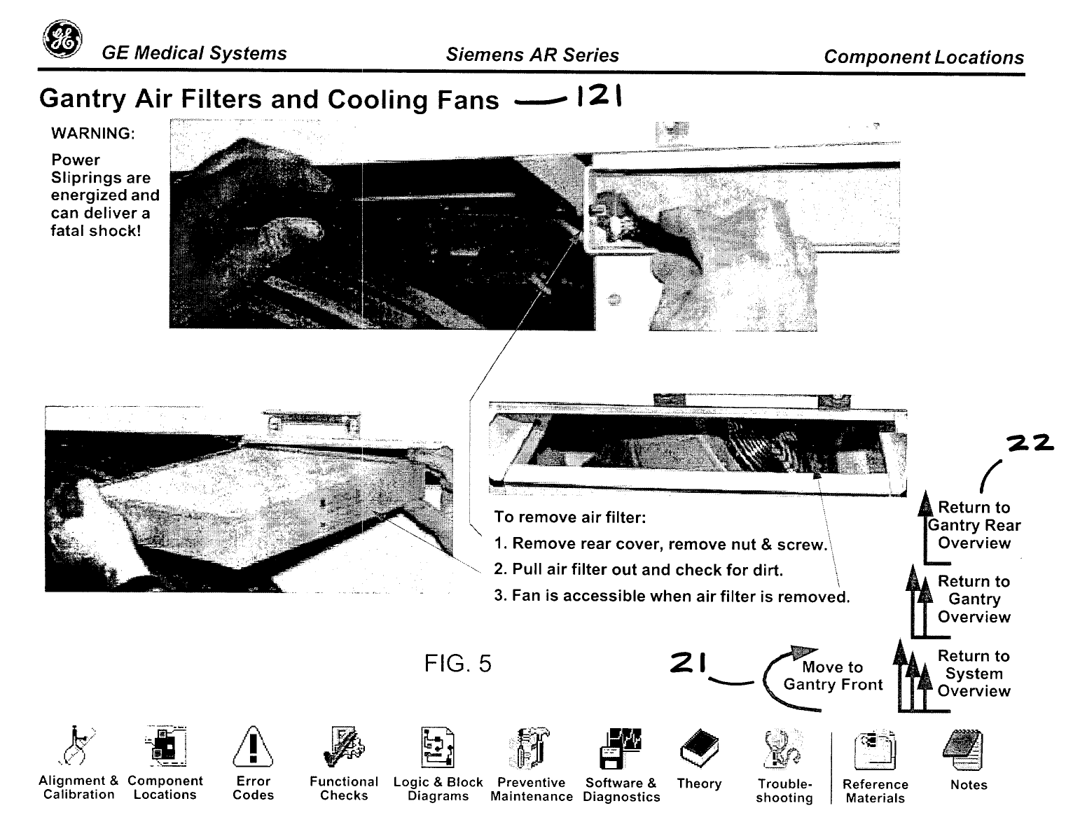

Referring again to the main display page for the AR CT machine as shown in FIG. 1, the field engineer can next locate any component within the machine by scrolling to the “Component Locations” icon 20 and clicking on it. This would open a screen display as that shown in FIG. 4. In the case of the AR CT of the present example, the pictorially displayed location of various components, such as the gantry front 21, the gantry rear 22, the table 23, the PDS cabinet 24, the IMS cabinet 25, the console 26, the uninterruptible power supply 27, the search suppresser 28, and the tube change and tune-up tools 29 can be accessed by clicking on the category required. Clicking on the subcategory “Air Filters and Cooling Fans” 121 under the category “Gantry Rear” 22, would display the procedure for accessing and replacing the air filter as shown in FIG. 5. Each serviceable area of the machine is pictorially displayed, and each is provided with a number of hyperlinked subcategories which illustrate and display those portions of the machine that the field engineer may be viewing when he or she is in the process of accessing the internal components of the particular device.

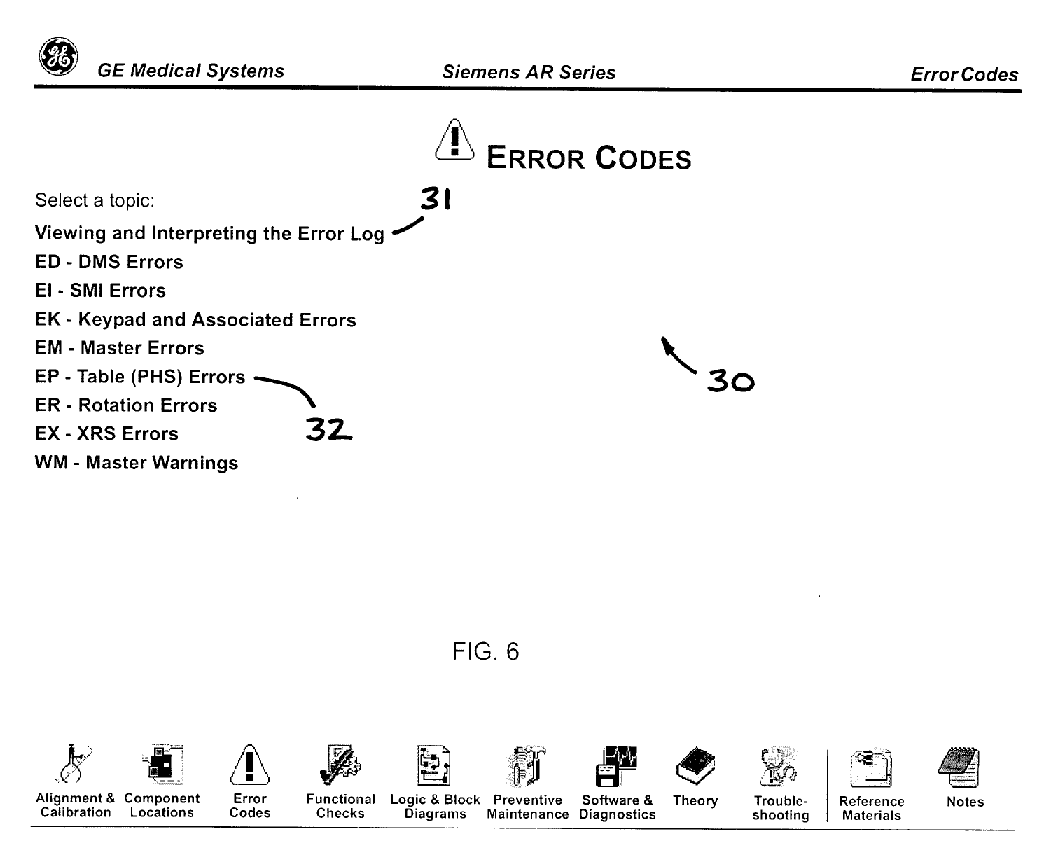

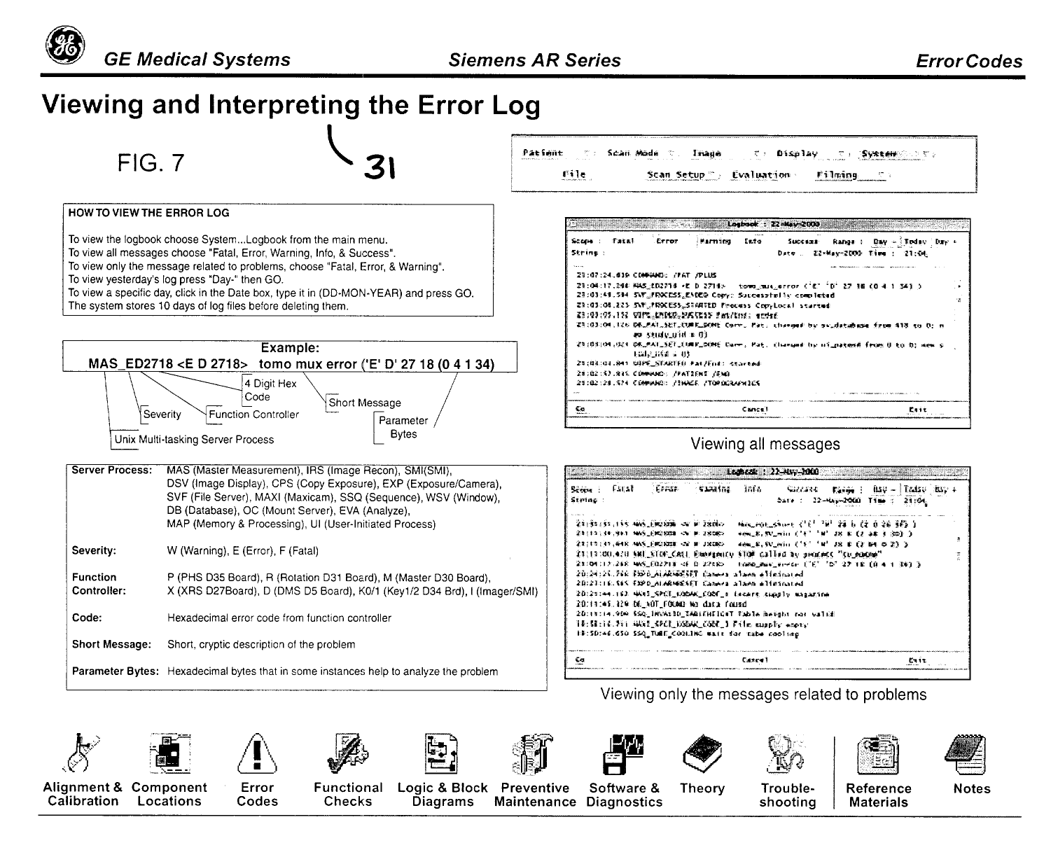

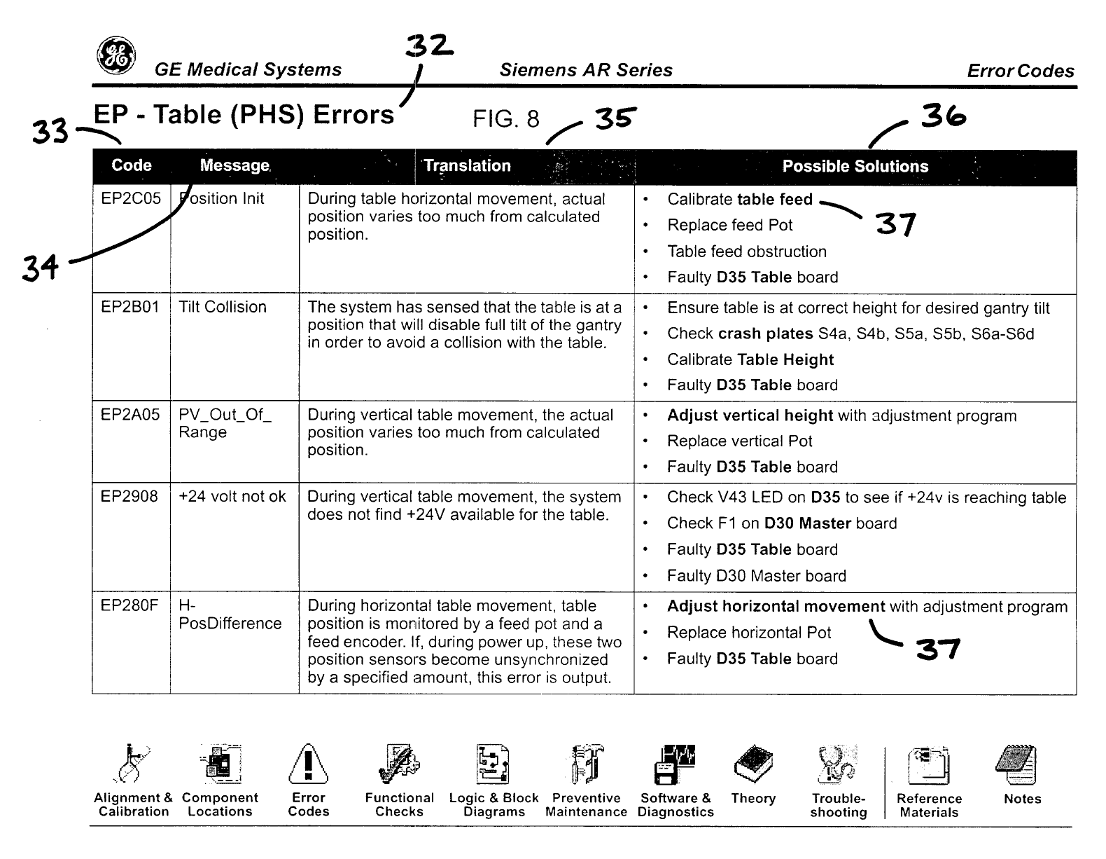

Another area that is available for the training and field service work of the field engineer includes the various error codes which will turn up as displays on an error log. Referring again to FIG. 1, clicking on the “Error Log” icon 30 brings the field engineer to a screen display as shown in FIG. 6. This display includes a number of subcategories including “Viewing and Interpreting the Error Log” 31. The field engineer can be trained by, and becomes familiar with, the viewing and interpreting of the error log as it relates to this particular piece of equipment. See FIG. 7. As shown in FIG. 6, other topics of potential error are displayed and are accessible by the field engineer who only needs to click on the topic desired to access relevant error codes. In the case of error messages that would or could be displayed relative to the patient handling system (PHS), the field engineer would click on the topic entitled “EP—Table (PHS) Errors” 32 and would gain additional access to a screen display as shown in FIG. 8. In that display, a number of error codes 33 are indexed with the error message 34, the translation 35 for that message and the list of possible solutions 36 that the field engineer may attempt in the effort to clear the error message. Here again, various hyperlinks 37 are provided that allow the field engineer to cross-reference other helpful and useful information for dealing with the problem at hand.

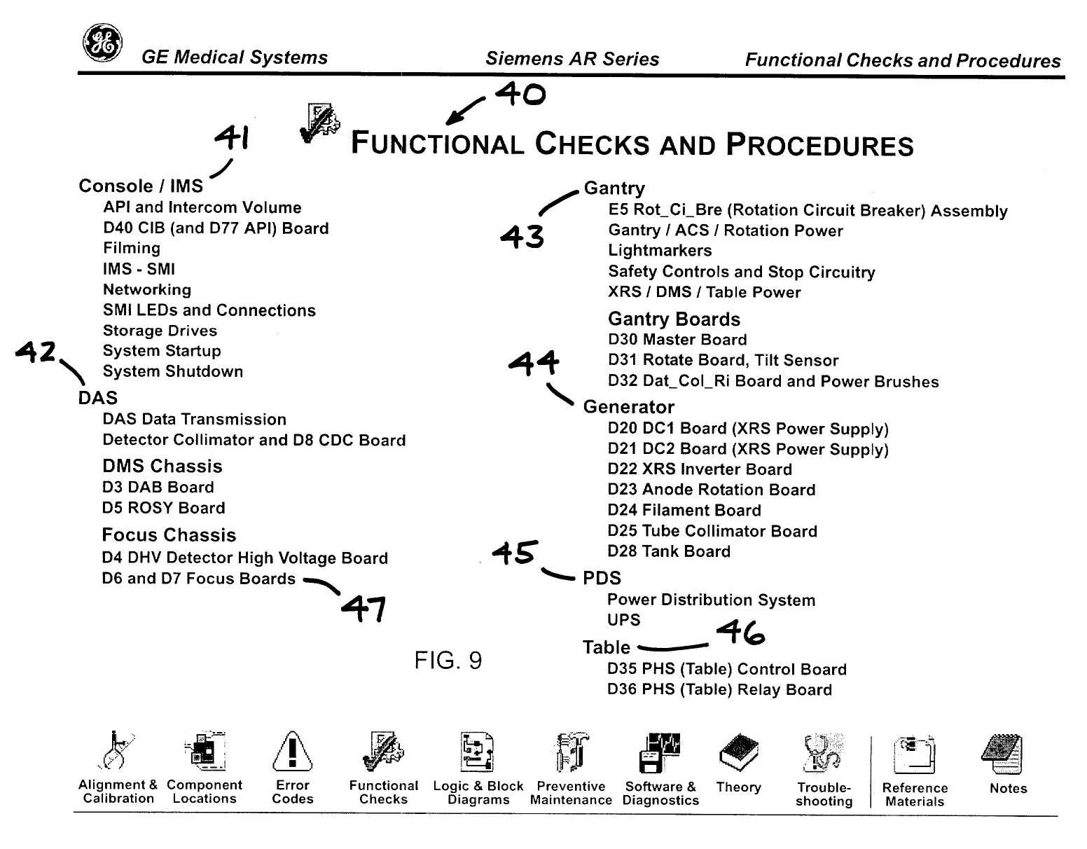

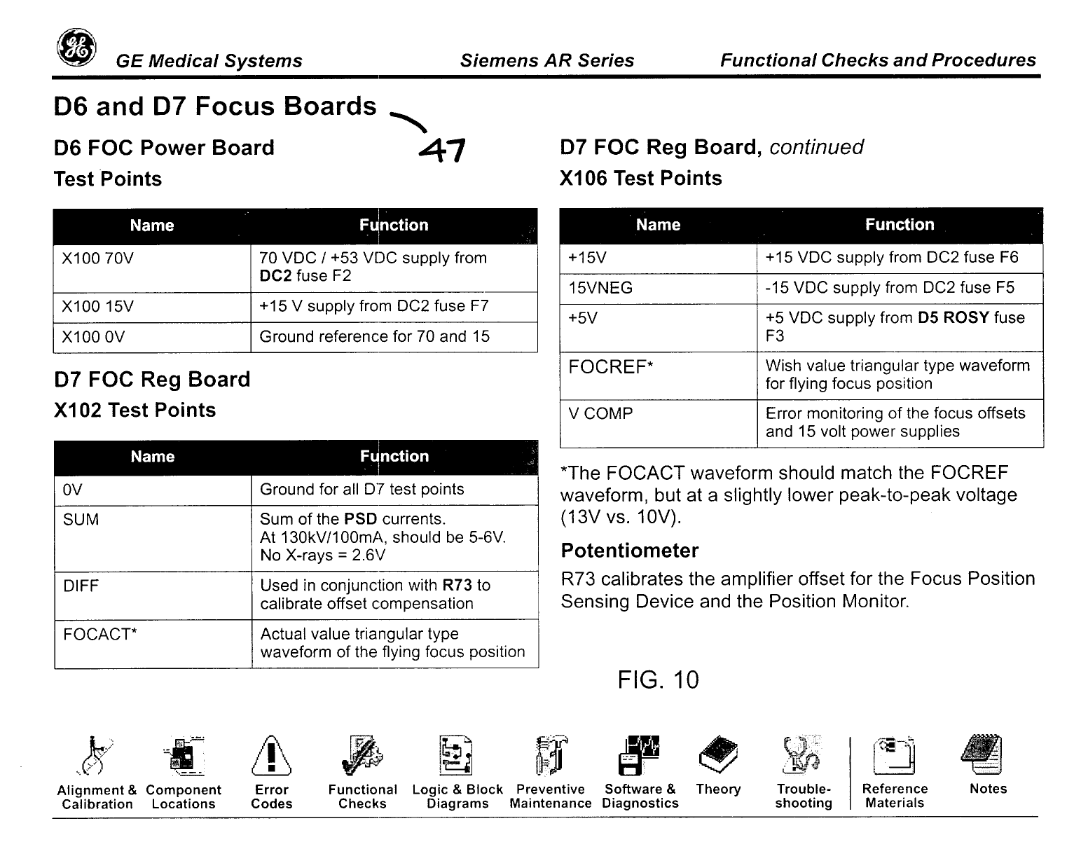

The field engineer is also provided with a number of functional checks and procedures that go into detail as to various portions of the machine and particular machine elements. For example, in the case of the AR CT, the field engineer may click on the “Functional Checks and Procedures” icon 40 as shown in FIG. 1 to gain access to a display screen as shown in FIG. 9. From here, the field engineer may access functional check and procedure information on such machine elements as the console 41, the data acquisition system 42, the gantry 43, the imaging generator 44, the power distribution system 45, and the patient handling system 46. If the field engineer wanted to locate the test points, for example, of the D6 and D7 Focus Boards of the AR CT machine, the field engineer would click on the “D6 and D7 Focus Boards” term 47 on the screen shown in FIG. 9. This would result in a new screen display as shown in FIG. 10 which would provide the name and function of various test points on the D6 FOC Power Board and the D7 FOC Reg Board, among other helpful information.

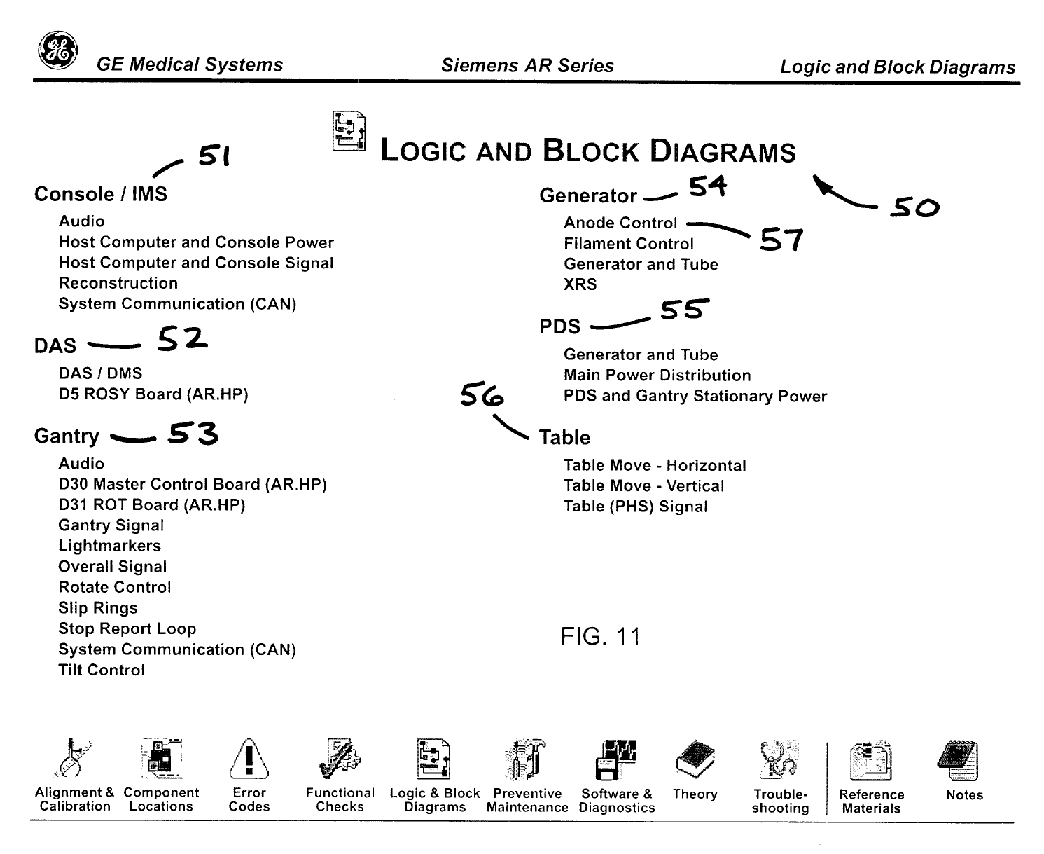

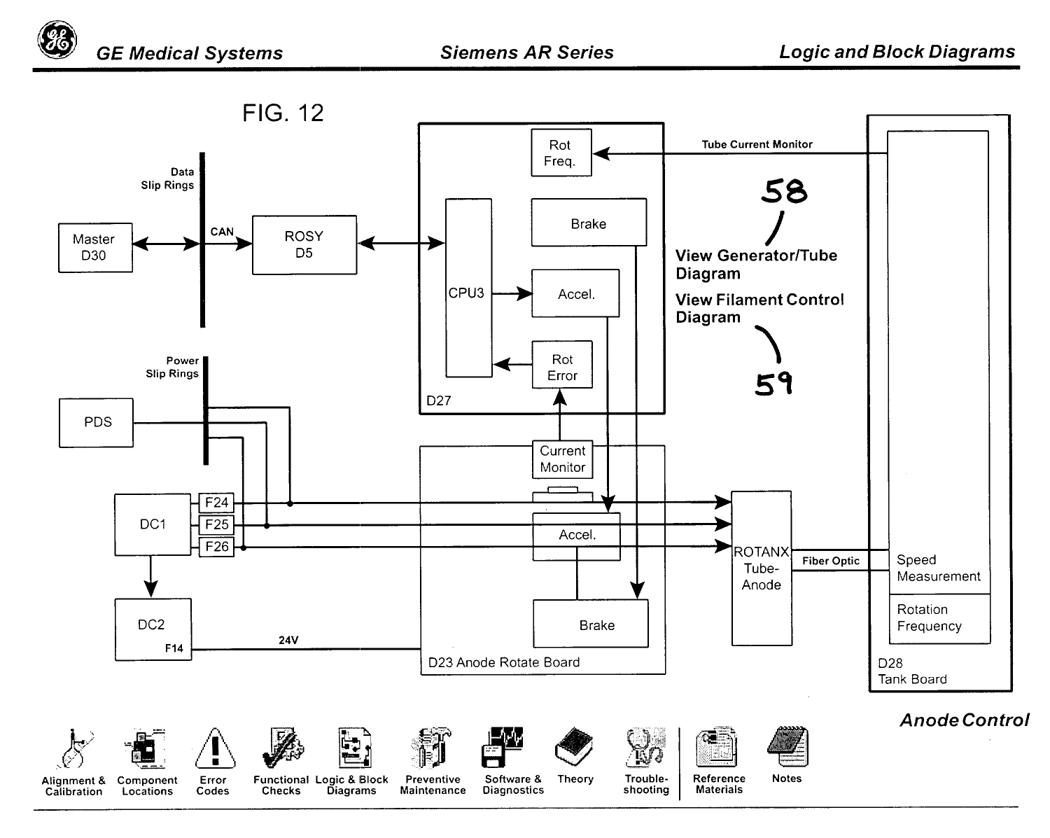

Next, the method and program of the present invention provides the field engineer with access to a number of logic and block diagrams with respect to the various elements of the machine that is being learned about or field examined. Referring again to the main OEM product display page as shown in FIG. 1, the field engineer can access this information by clicking on the “Logic and Block Diagrams” icon 50 which will bring up a display screen as shown in FIG. 11. The logic and block diagram options, in the case of the AR CT device, include diagrams relating to the console 51, the DAS 52, the gantry 53, the generator 54, the PDS 55, and the table 56. The field engineer could then access any subcategory as shown in FIG. 11 which would lead to a display for a specific logic and block diagram. For example, by clicking on the words “Anode Control” 57 under the “Generator” 54 heading, the field engineer would be provided with a diagram such as that shown in FIG. 12. From there, it should be noted that hyperlink access to two other diagrams 58, 59 is also provided.

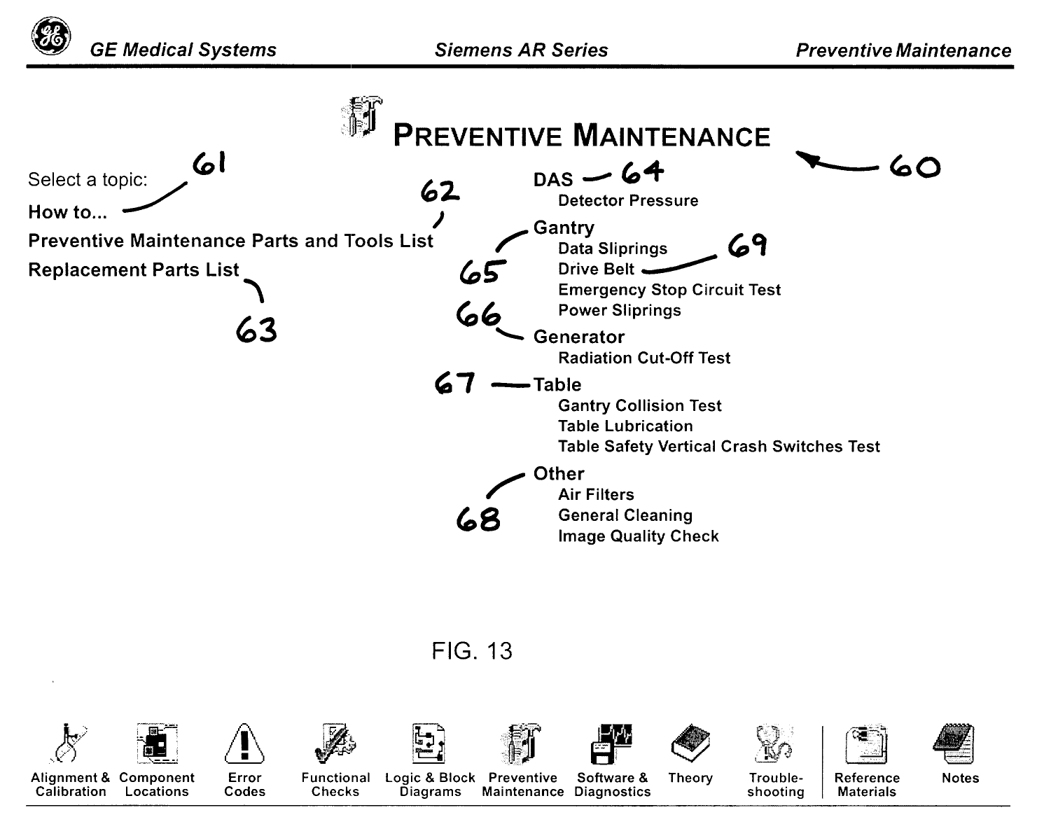

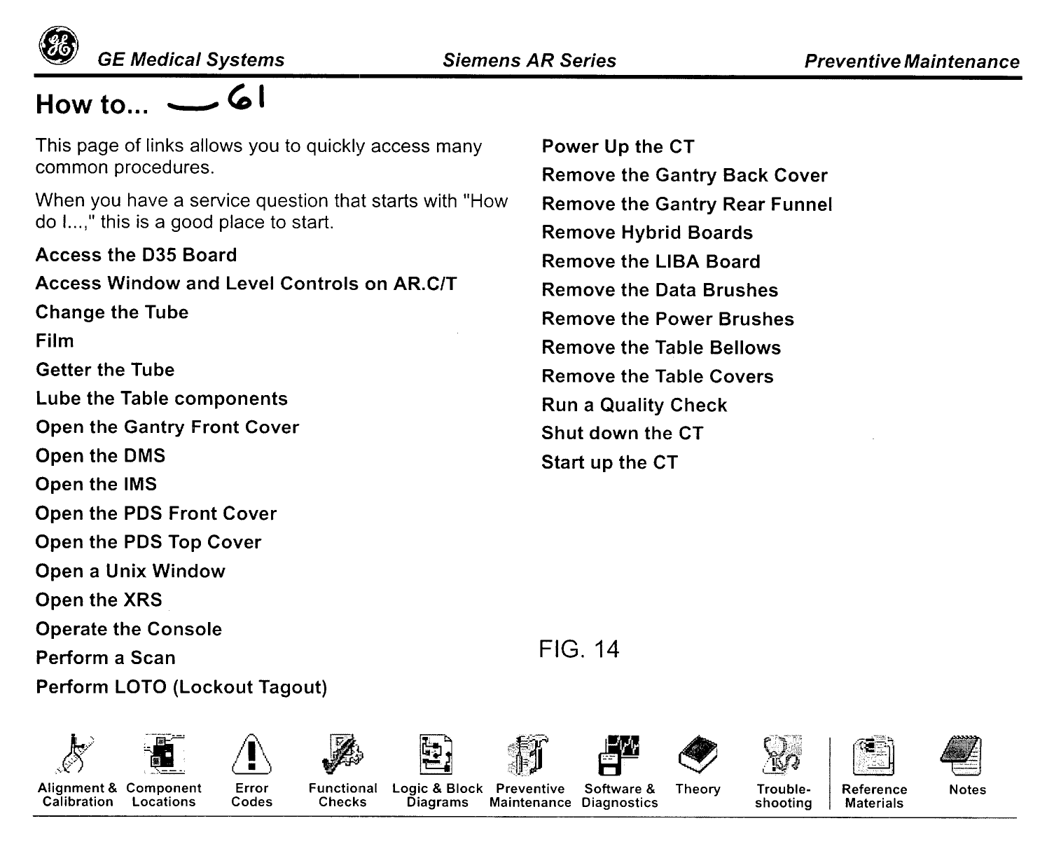

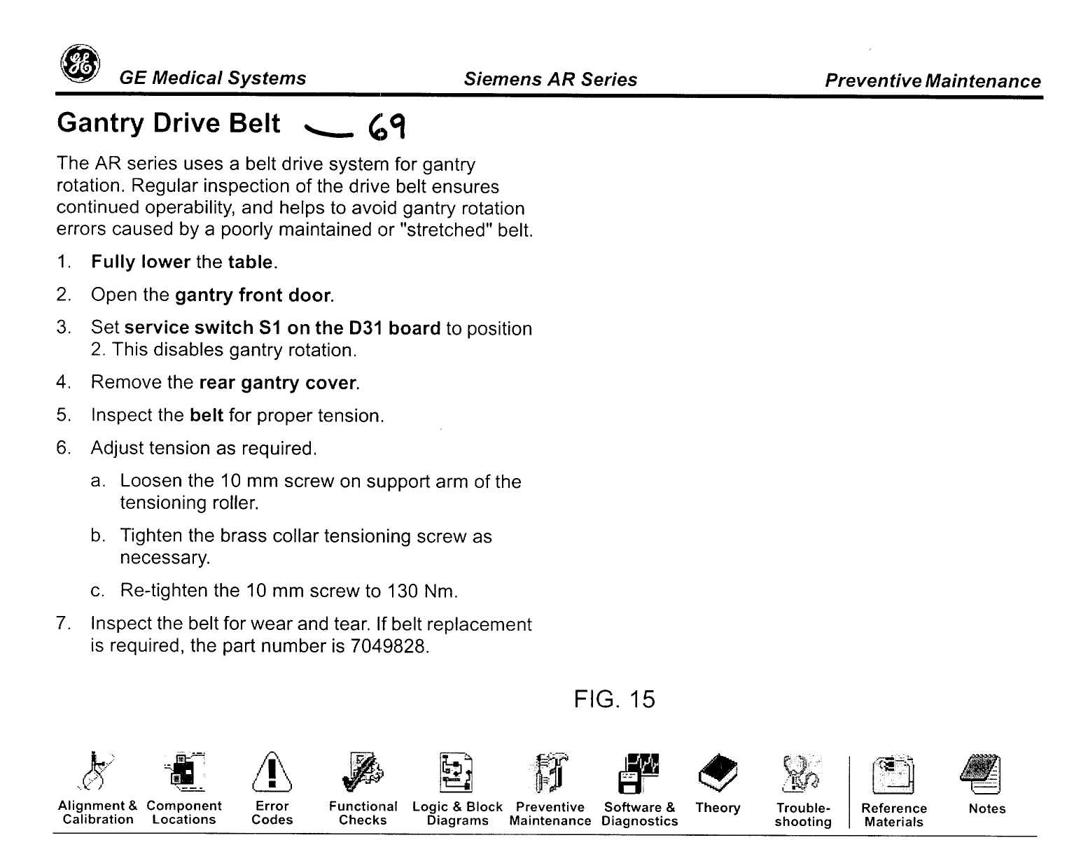

Another section that is provided for the use by the field engineer is entitled “Preventive Maintenance” 60. See FIG. 1. The subject of preventive maintenance 60 can be accessed by the field engineer by clicking the “Preventive Maintenance” 60 icon to demonstrate how to perform various preventive maintenance functions. The display screen as shown in FIG. 13 shows a number of functions that can be performed under the categories of “How to . . . ” 61, “Preventive Maintenance Parts and Tools List” 62, and “Replacement Parts List” 63. Other specific areas include preventive maintenance of the DAS 64, the gantry 65, the generator 66, the table 68 and other miscellaneous items 68. Clicking on the “How to . . . ” 61 legend brings up a screen display as shown in FIG. 14. If the field engineer were considering preventive maintenance on the gantry drive belt, for example, the field engineer would click on the legend “Gantry Drive Belt” 69 as shown in FIG. 13 which would bring up a screen display as shown in FIG. 15. The steps given there would be followed by the field engineer. Here again, a number of hyperlinks are provided to assist the field engineer with this preventive maintenance work. Any number of such preventive maintenance sections are provided for use in training of the field engineer as well. The sections available for any given machine are widely variable depending upon construction, physical configuration, energization and control.

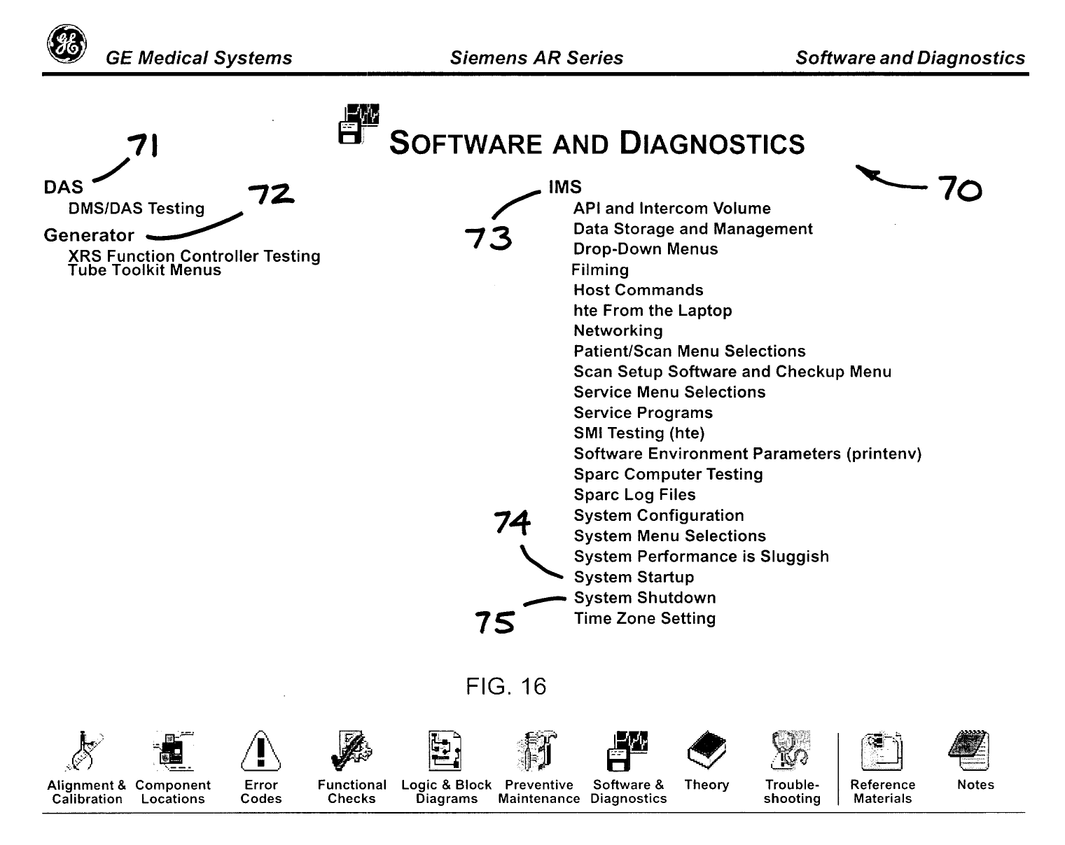

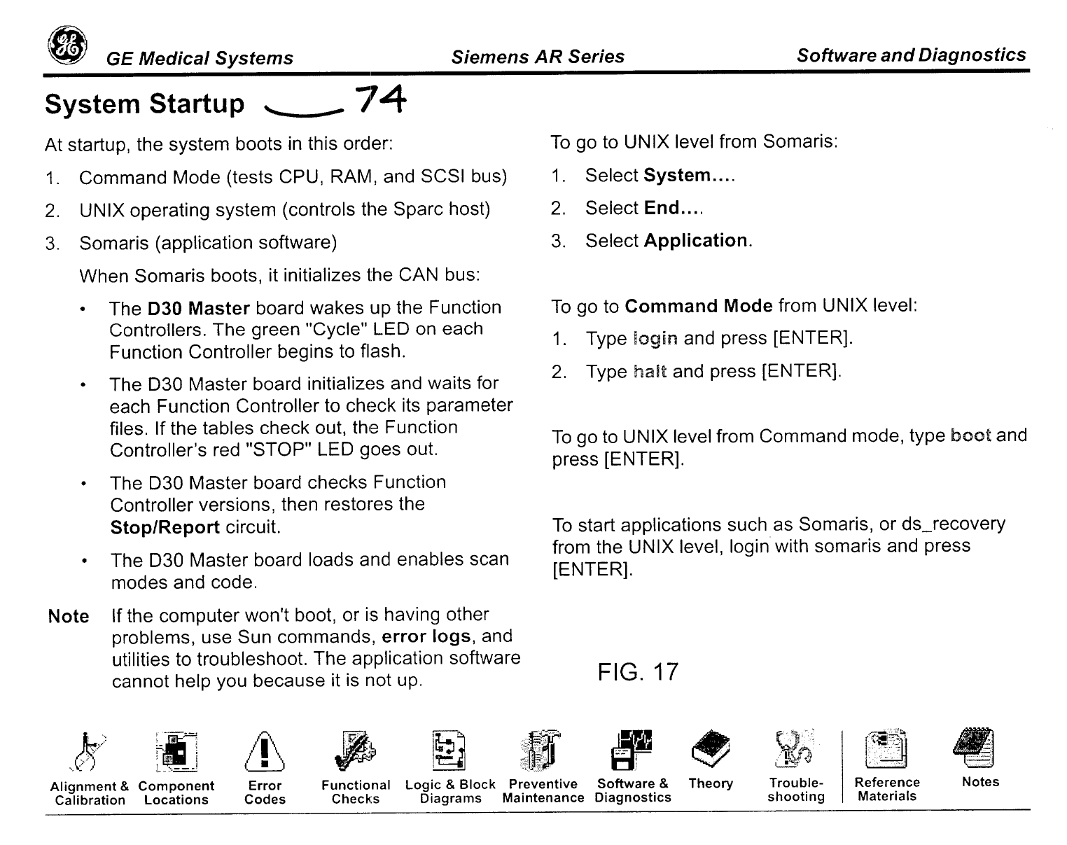

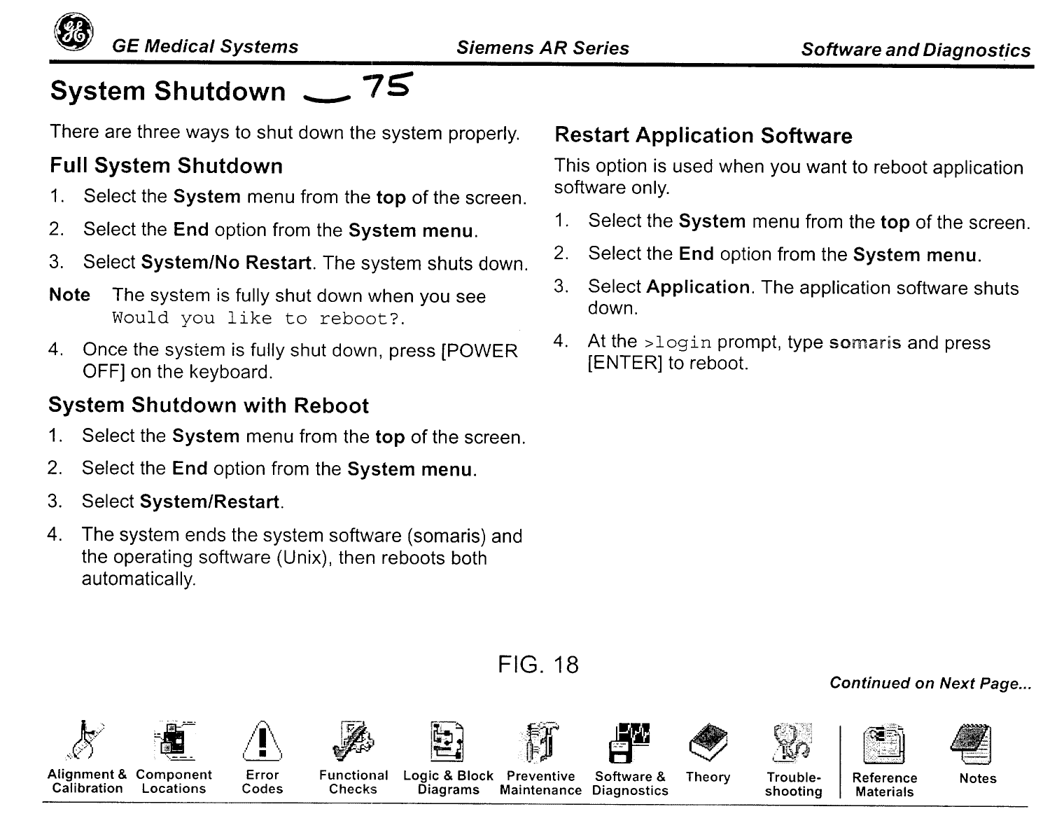

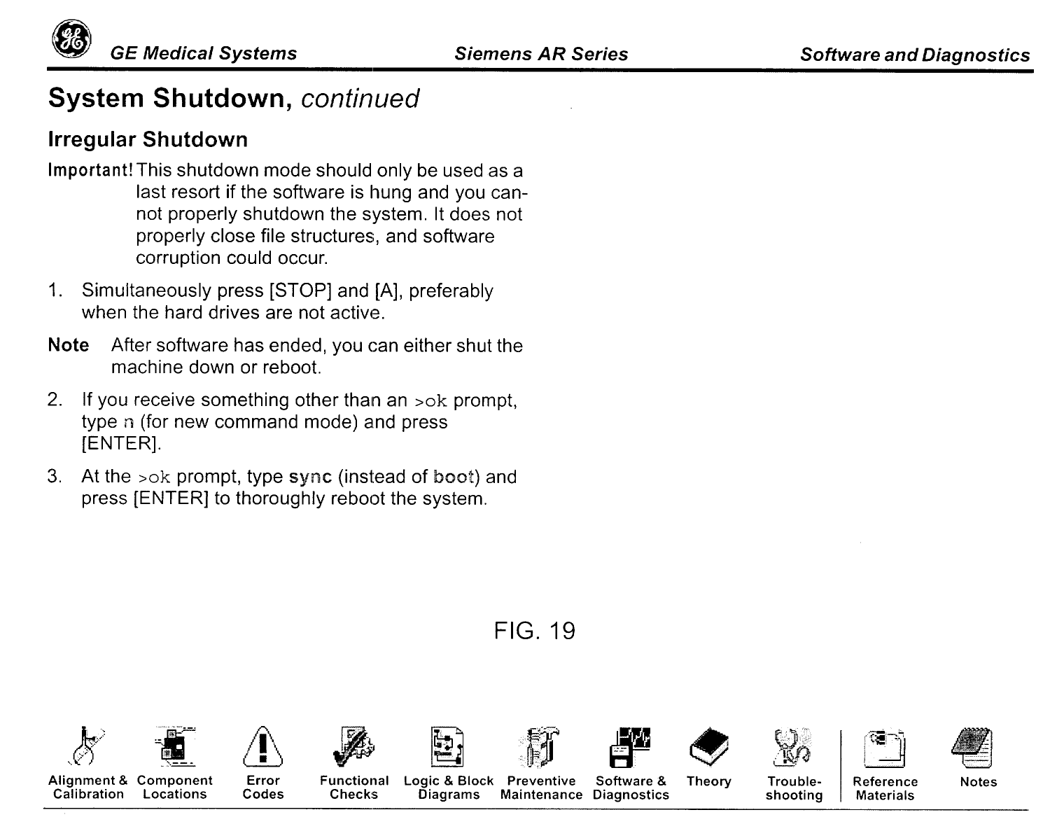

Another section that is provided for each OEM device is the area of software and diagnostics, accessible by use of the “Software and Diagnostics” icon 70 shown in FIG. 1. Clicking on that icon 70 results in a screen display such as that shown in FIG. 16. In the case of the AR CT, software and diagnostics guidance is provided such that the field engineer can access information relating to the performance of the DAS 71, the generator 72 and the various IMS systems 73 of the AR CT machine. By way of example, the “System Startup” legend 74 and the “System Shutdown” legend 75 provide command selection options as shown in FIGS. 17-19, respectively. Here again, note that a number of hyperlinks are also provided to coordinate system function with system hardware.

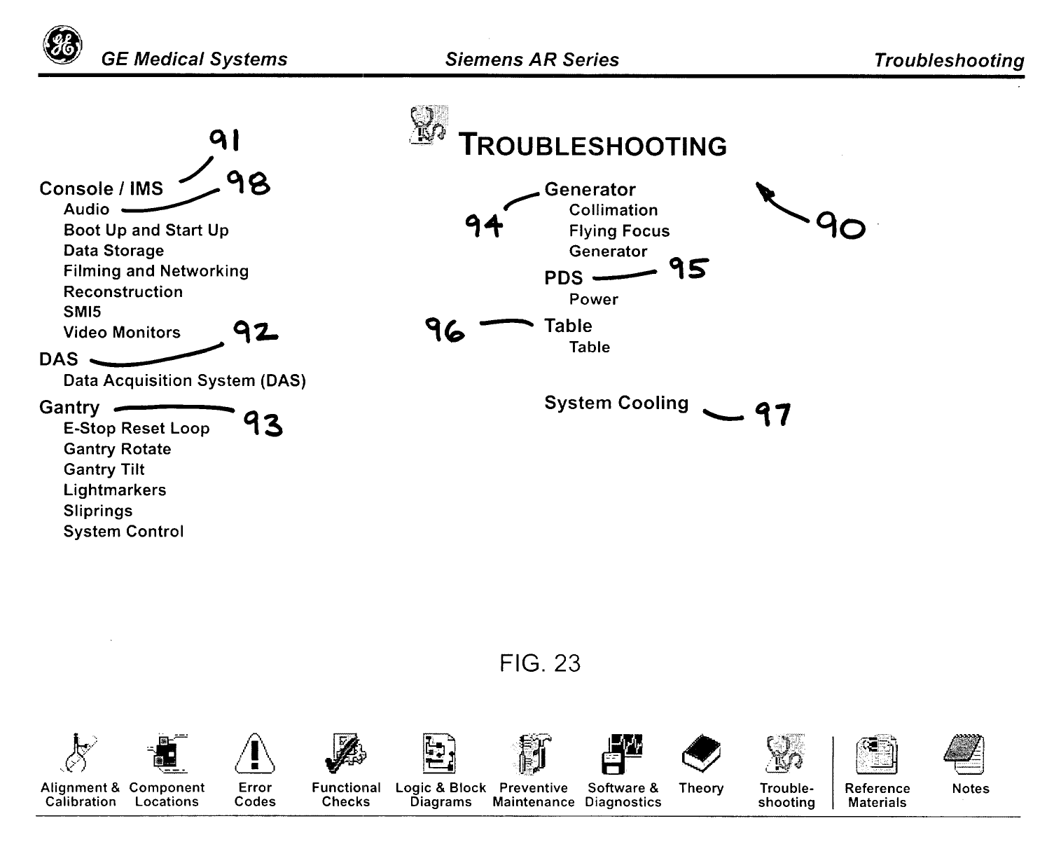

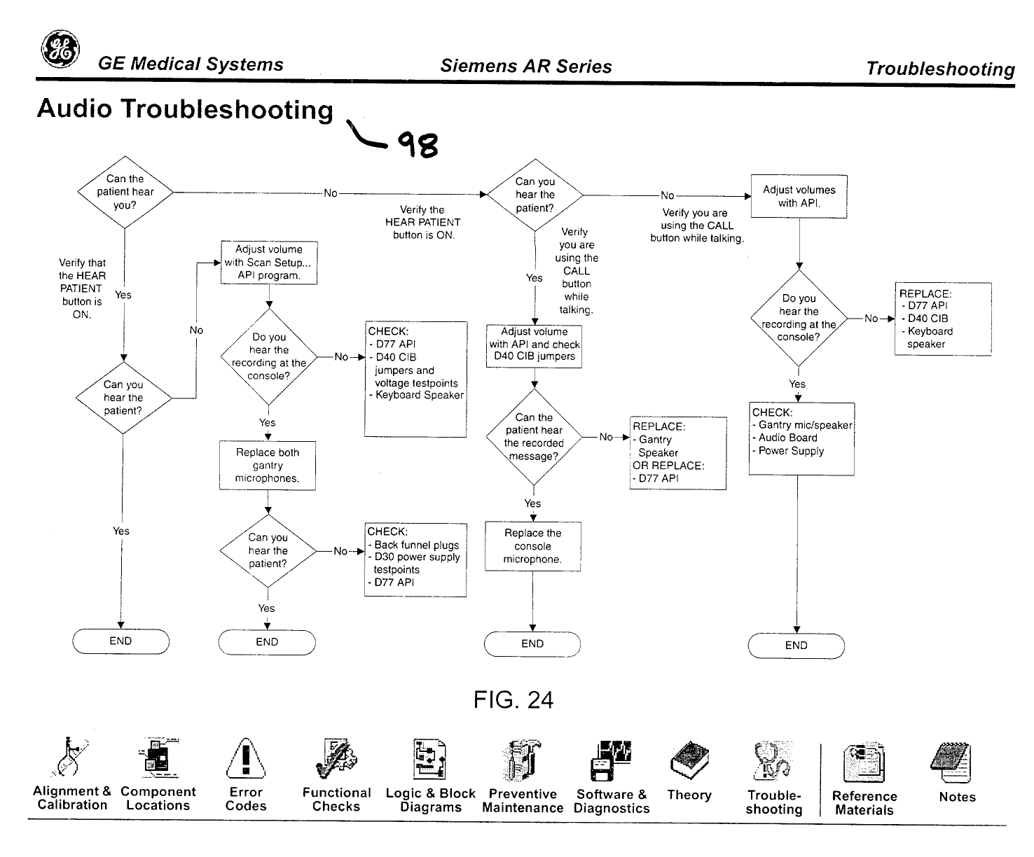

Another area that is provided for use by the field engineer in the method and program of the present invention is troubleshooting. By clicking on the “Troubleshooting” icon 90 in the display screen shown in FIG. 1, the field engineer can access the screen display as shown in FIG. 23. In the case of the AR CT, the troubleshooting section covers such areas as problems relating to the console 91, the data acquisition system 92, the gantry 93, the generator 94, the power distribution system 95, the table 96 and the cooling system 97 of the device. Clicking on the legend “Audio” 98 under the legend “Console/IMS” 91 allows the field engineer access to the screen display as shown in FIG. 24 which provides a flow chart for troubleshooting the various components of the audio system. It starts with the questions of whether or not the patient that is being examined can hear the troubleshooter and whether or not the troubleshooter can hear the patient. Depending upon the answers given to those questions, the field engineer is given a number of options to investigate in the troubleshooting process.

Based on the foregoing, it will be seen that the method and program of the present invention provides a CD-ROM based tool, known as the multivendor electronic performance support tool with self-paced training (ePST/SPT), that is designed from a field service and training perspective instead of an engineering perspective. The method and program provides service documentation in a consistent format and structure throughout each OEM and modality product. The method of the present invention further provides a system function—service function approach. It provides interlinked logic diagrams, diagnostic questions and calibration information required to service system functions, as opposed to system components. Information required to repair system components is then electronically recalled by the field engineer as desired or required. The method and program may be used as a training tool and in the field as a service tool.

Parts List:

| | |
|---|---|
| 10 | Alignment and calibration hyperlink |
| 11 | Complete tune-up procedure table link |
| 12 | Console/IMS link |
| 13 | Data acquisition system link |
| 14 | Gantry link |
| 15 | Generator link |
| 16 | Table link |
| 17 | Gantry tilt adjustment link |
| 20 | Component locations hyperlink |
| 21 | Gantry front link |
| 22 | Gantry rear link |
| 23 | Table link |
| 24 | PDS cabinet link |
| 25 | IMS cabinet link |
| 26 | Console link |
| 27 | uninterruptible power supply link |
| 28 | Surge suppressor link |
| 29 | Tube change and tune-up tools link |
| 30 | Error codes hyperlink |
| 31 | Viewing and interpreting the error log link |
| 32 | EP-table (PHS) errors link |
| 33 | Code display |
| 34 | Message display |
| 35 | Translation display |
| 36 | Possible solutions display |
| 37 | Table feed link/adjust horizontal movement link |
| 40 | Functional checks and procedures hyperlink |
| 41 | Console/IMS link |
| 42 | DAS link |
| 43 | Gantry link |
| 44 | Generator link |
| 45 | Power distribution system link |
| 46 | Table link |
| 47 | D6 and D7 focus boards link |
| 50 | Logic and block diagrams hyperlink |
| 51 | Console/IMS link |
| 52 | DAS link |
| 53 | Gantry link |
| 54 | Generator link |
| 55 | PDS link |
| 56 | Table link |
| 57 | Anode Control link |
| 58 | View generator/tube diagram link |
| 59 | View filament control diagram link |
| 60 | Preventive maintenance hyperlink |
| 61 | How to link |
| 62 | Preventive maintenance parts and tools list link |
| 63 | Replacement parts list link |
| 64 | DAS link |
| 65 | Gantry link |
| 66 | Generator link |
| 67 | Table link |
| 68 | Other link |
| 69 | Gantry drive belt link |
| 70 | Software and diagnostics hyperlink |
| 71 | Data acquisition system link |
| 72 | Generator link |
| 73 | IMS link |
| 74 | System startup link |
| 75 | System shutdown link |
| 80 | Theory hyperlink |
| 81 | Console/IMS link |
| 82 | DAS link |
| 83 | Gantry link |
| 84 | Generator link |
| 85 | PDS link |
| 86 | Table link |
| 87 | High voltage and x-ray generation link (overview) |
| 88 | High voltage and x-ray generation link (self-test) |
| 90 | Trouble shooting link |
| 91 | Console/IMS link |
| 92 | DAS link |
| 93 | Gantry link |
| 94 | Generator link |
| 95 | PDS link |
| 96 | Table link |
| 97 | System cooling link |
| 98 | Audio link |
| 100 | Hyperlink display link |
| 110 | Equipment modality display link |
| 121 | Gantry air filter and cooling fan display link |

What is claimed is:

1. A method for providing multivendor electronic performance support and self-paced training for field engineers comprising the steps of
providing a screen display for at least one original equipment modality (110), and
including as part of the screen display a plurality of hyperlinks (100) to areas of technical information relating to the equipment modality,
wherein the field engineer can access one or more of the technical hyperlinks (100) for obtaining technical information relating to the equipment modality (110).

2. The method of claim 1 wherein one of the technical hyperlinks (100) included is for alignment and calibration information (10) relating to that equipment modality (110).

3. The method of claim 1 wherein one of the technical hyperlinks (100) included is for component locations (20) relating to that equipment modality (110).

4. The method of claim 1 wherein one of the technical hyperlinks (100) included is for error codes (30) relating to that equipment modality (110).

5. The method of claim 1 wherein one of the technical hyperlinks (100) included is for functional checks (40) relating to that equipment modality (110).

6. The method of claim 1 wherein one of the technical hyperlinks (100) included is for logic and block diagrams (50) relating to that equipment modality (110).

7. The method of claim 1 wherein one of the technical hyperlinks (100) included is for preventive maintenance (60) relating to that equipment modality (110).

8. The method of claim 1 wherein one of the technical hyperlinks (100) included is for software and diagnostics (70) relating to that equipment modality (110).

9. The method of claim 1 wherein one of the technical hyperlinks (100) included is for the theory (80) relating to that equipment modality (110).

10. The method of claim 1 wherein on of the technical hyperlinks (100) included is for troubleshooting (90) of that equipment modality (110).

11. The method of claim 1 wherein each technical hyperlink (10, 20, 30, 40, 50, 60, 70, 80, 90) includes a plurality of cross links between different technical information areas relating to the equipment modality (110).

12. A method for providing multivendor electronic performance support for field engineers comprising the steps of
providing a screen display for at least one original equipment modality (110), and
including as part of the screen display one or more hyperlinks (100) relating to
(a) alignment and calibration (10),
(b) component locations (20),
(c) error codes (30),
(d) functional checks (40),
(e) logic and block diagrams (50),
(f) preventive maintenance (60),
(g) software and diagnostics (70),
(h) theory (80), and/or
(i) troubleshooting (90),
wherein the field engineer can access one or more of the technical hyperlinks (100) for obtaining one or more screen displays of technical information relating to the equipment modality (110).

13. The method of claim 12 wherein each technical hyperlink (10, 20, 30, 40, 50, 60, 70, 80, 90) includes a plurality of cross links between different technical information areas relating to the equipment modality (110).

14. The method of claim 13 including the step of providing self-paced training of the field engineer by use of the plurality of screen displays (10, 20, 30, 40, 50, 60, 70, 80, 90).

15. A program for use with a computer in providing multivendor electronic performance support and self-paced training for field engineers comprising
a screen display for at least one original equipment modality (110),
said screen display including a plurality of hyperlinks (100) to areas of technical information relating to the equipment modality (110),
wherein the field engineer can access one or more of the technical hyperlinks (100) for obtaining technical information relating to the equipment modality (110).

16. The program of claim 15 wherein one of the technical hyperlinks (100) included is for alignment and calibration (10) information relating to that equipment modality (110).

17. The program of claim 15 wherein one of the technical hyperlinks (100) included is for component locations (20) relating to that equipment modality (110).

18. The program of claim 15 wherein one of the technical hyperlinks (100) included is for error codes (30) relating to that equipment modality (110).

19. The program of claim 15 wherein one of the technical hyperlinks (100) included is for functional checks (40) relating to that equipment modality (110).

20. The program of claim 15 wherein one of the technical hyperlinks (100) included is for logic and block diagrams (50) relating to that equipment modality (110).

21. The program of claim 15 wherein one of the technical hyperlinks (100) included is for preventive maintenance (60) relating to that equipment modality (110).

22. The program of claim 15 wherein one of the technical hyperlinks (100) included is for software and diagnostics (70) relating to that equipment modality (110).

23. The program of claim 15 wherein one of the technical hyperlinks (100) included is for the theory (80) relating to that equipment modality (110).

24. The program of claim 15 wherein on of the technical hyperlinks (100) included is for troubleshooting (90) of that equipment modality (110).

25. The program of claim 15 wherein each technical hyperlink includes a plurality of cross links between different technical information areas relating to the equipment modality (110).

26. A computer program for providing multivendor electronic performance support for field engineers comprising
a screen display for at least one original equipment modality (110), and
including as part of the screen display one or more hyperlinks (100) relating to
(a) alignment and calibration (10),
(b) component locations (20),
(c) error codes (30),
(d) functional checks (40),
(e) logic and block diagrams (50),
(f) preventive maintenance (60),
(g) software and diagnostics (70),
(h) theory (80), and/or
(i) troubleshooting (90),
wherein the field engineer can access one or more of the technical hyperlinks (100) for obtaining one or more screen displays of technical information relating to the equipment modality (110).

27. The program of claim 26 wherein each technical hyperlink includes a plurality of cross links between different technical information areas relating to the equipment modality (110).

28. The program of claim 26 wherein the field engineer may use the program for self-paced training by use of the plurality of hyperlinks, cross links and screen displays (100, 110).

29. A computer program for training field engineers in multivendor modality support which comprises
an original equipment database,
a screen display for viewing one or more original equipment modalities in the data base,
said screen display including one or more hyperlinks (100) to technical information areas relative to that equipment modality (110), and
means for providing cross links between the technical information areas.

30. The program of claim 29 wherein the areas of technical information include one or more of
(a) alignment and calibration (10),
(b) component locations (20),
(c) error codes (30),
(d) functional checks (40),
(e) logic and block diagrams (50),
(f) preventive maintenance (60),
(g) software and diagnostics (70),
(h) theory (80), and/or
(i) troubleshooting (90),
wherein the field engineer can access one or more of the technical hyperlinks (100) for obtaining one or more screen displays of technical information relating to the equipment modality (110).

31. The program of claim 30 wherein the field engineer can use the program in the field as a tool for servicing equipment.
